(19) United States
(12) Patent Application Publication
(10) Pub. No.: US 2024/0144245 A1
(43) Pub. Date: May 2, 2024

(54) DIGITAL WALLET INTEGRATION FOR ONLINE SERVICES

(71) Applicant: NCR Corporation, Atlanta, GA (US)

(72) Inventor: Sunil Kumar Bhandekar, Hyderabad (IN)

(21) Appl. No.: 17/975,952

(22) Filed: Oct. 28, 2022

(51) Int. Cl. G06Q 20/36; G06Q 20/10; G06Q 20/32; G06Q 20/38

(52) U.S. Cl. CPC G06Q 20/3674; G06Q 20/108; G06Q 20/326; G06Q 20/381; G06Q 20/389; G06Q 2220/00

(57) ABSTRACT

An interface associated with a fiat currency account of a customer is enhanced to accept payment on the account via a digital wallet of the customer. A gateway service is processed when the option is selected which causes payment in a customer's wallet to be transferred over a blockchain to a gateway service's wallet. The gateway service then transfers an equivalent amount from a financial account of the gateway service to a financial institution's account. The gateway service also provides an account identifier for the account of the customer to the financial institution. The financial institution credits the amount as payment received from the customer and updates the interface to include the payment and the credited amount on the account.

### BACKGROUND

Many consumers have a variety of digital wallets associated with online payment services, such as PayPal®, Venmo®, Zell®, and others. Frequently, these services are used almost exclusively within the context of peer-to-peer transactions. For example, if one person of a party pays for a dinner, each of the other individuals in the party will pay the payer for their portion of the meal using an online payment service. With some exceptions, these services are largely used by individuals for small amounts associated with consumer-to-consumer payments.

A sizeable number of consumers also possess cryptocurrency wallets for cryptocurrency. For the most part, consumers hold their cryptocurrency as investments and usually only buy or sell the cryptocurrency from their cryptocurrency wallets via a cryptocurrency exchange. In fact, few business will allow a consumer to pay for a transaction via cryptocurrency. Some businesses are not even allowed to accept or handle cryptocurrency, such as fiat currency-based financial institutions.

Credit cards are the preferred payment method of consumers for transactions involving goods and services; some businesses no longer accept fiat currency as payments; the pandemic also accelerated this trend of payments via credit cards. However, this has created a problem for many consumers because if charges placed on their cards are not repaid in full before a next billing cycle, the financial institutions charge a hefty interest rate. Nowadays, the financial institutions that provide credit cards only accept payment from a financial account of the consumer, which means that the consumer can not pay a balance due on one card with a different card held with a different financial institution. If a consumer's available balance in a financial account is insufficient to cover what is due of the consumer with a financial institution on the payment due date, the financial institution will charge additional late fees on top of the interest.

A lot of consumers are facing a no-win situation with interest rates rising and inflation raging, their outstanding credit card balances are soaring as consumers use their cards to pay for necessities. The interest rates and late payment fees are mounting, and consumers are under water financially even though these consumers may have the necessary assets to make their payments via cryptocurrency assets when the payments are due.

### SUMMARY

In various embodiments, methods and a system for digital wallet integration with online services are presented. A gateway service is processed during a fiat currency account payment made by a consumer to a financial institution (FI). The gateway service is invoked from within an enhanced interface to an existing FI application provided to the consumer for managing the consumer's account when the consumer selects a payment by crypto option to make payment on the fiat currency account. The gateway service presents an interface for the consumer to link a cryptocurrency wallet to the fiat currency account with the FI and select an amount in fiat currency that the consumer wants to pay on the account. The gateway service obtains an equivalent amount from cryptocurrency held by the consumer in the wallet and initiates a blockchain transaction to transfer the amount of cryptocurrency from the consumer's wallet to a second wallet managed by the gateway service. The gateway service transfers the fiat currency amount from a fiat currency account of the gateway service to a fiat currency account of the FI as payment by the consumer on the fiat currency account that the consumer has with the FI. The FI credits the consumer's account with the payment.

### BRIEF DESCRIPTION OF THE DRAWINGS

FIG. 1 is a diagram of a system for digital wallet integration with online services, according to an example embodiment.

FIG. 2 is a diagram of a method for digital wallet integration with online services, according to an example embodiment.

FIG. 3 is a diagram of another method for digital wallet integration with online services, according to an example embodiment.

### DETAILED DESCRIPTION

As stated above, fiat-currency financial institutions often are prohibited via regulations from holding, accepting, and handling cryptocurrencies. Thus, although a consumer may have cryptocurrency assets to pay a credit card balance due by the due date, the financial institution (FI) will only accept the payment from a fiat currency financial account of the consumer either via a bank-to-bank transfer or via a debit card linked to a fiat currency financial account of the consumer. This presents significant issues for consumers as not only are they hit with high interest rates on the outstanding balance, but they are also hit with late payment fees.

These issues are solved with the techniques presented herein and below. With the teachings herein, existing online and mobile interfaces associated with fiat currency FIs are enhanced to permit customers of the FIs to register cryptocurrency wallets of the customers as cryptocurrency accounts from which loan or credit card payments can be made and the payments credited by the FIs to the fiat currency accounts of the customers. The cryptocurrency and wallets are not held by nor handled by the FIs, rather, a cloud-based gateway is invoked when registering/linking the consumer's cryptocurrency wallet and when payment is collected and made to the FIs. The interfaces associated with the FIs' services are enhanced to present a payment by crypto option that when activated by a customer redirects the interface to a novel interface associated with the teachings presented herein. The customer registers/links one or more cryptocurrency wallets to the fiat currency account of the customer with the corresponding FI. The customer account with the FI is flagged to obtain payment through a gateway to a third-party service associated with the teachings presented herein. When payment is needed on the customer's fiat currency account, the gateway is activated based on the payment by crypto option being flagged on the fiat currency account, and the third-party service obtains an amount in cryptocurrency needed for the customer payment from the customer's crypto wallet balance over the blockchain. The third-party service transfers and equivalent amount in fiat currency to a fiat currency financial account associated with the FI. The FI's service then credits the account of the customer with the payment. The FI never handles the cryptocurrency nor manages the cryptocurrency and payment is received in fiat currency by the FI.

As used herein, the terms “consumer,” “customer,” “user,” and “debtor” refers to an individual with an account that requires a payment by the individual with a fiat currency FI for purposes of maintaining the account in good standing with the FI. The account can be associated with a credit card of the individual or a loan of the individual with the FI.

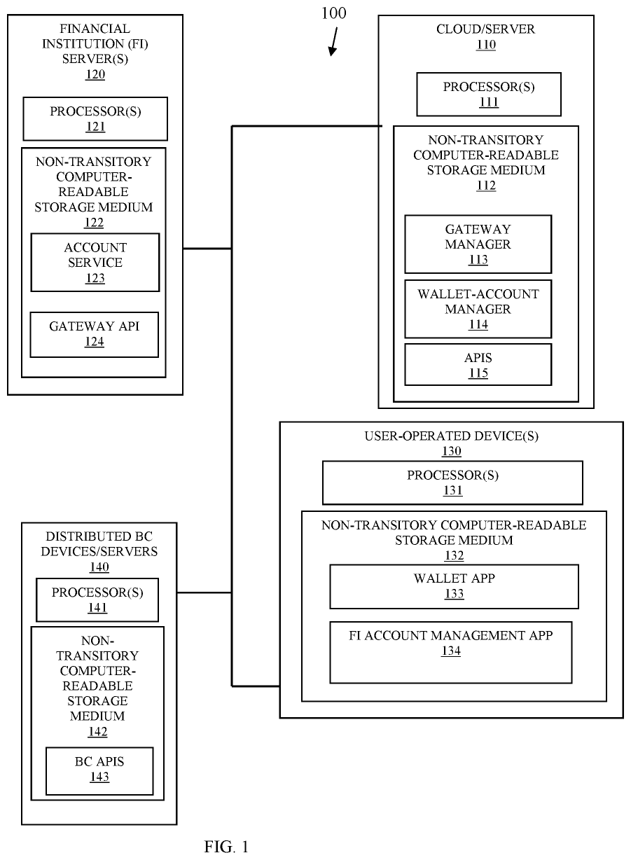

FIG. 1 is a diagram of a system 100 for digital wallet integration with online services, according to an example embodiment. The system 100 is shown schematically in greatly simplified form, with only those components relevant to understanding of one or more embodiments (represented herein) being illustrated. The various components are illustrated, and the arrangement of the components is presented for purposes of illustration only. It is to be noted that other arrangements with more or less components are possible without departing from the digital wallet integration with online services presented herein and below.

Moreover, various components are implemented as one or more software modules, which reside in non-transitory storage and/or hardware memory as executable instructions that when executed by one or more hardware processors perform the processing discussed herein and below.

As used herein the phrase “blockchain (BC) transaction” is intended to mean an executable BC command that when submitted to the BC moves cryptocurrency in a defined amount from one cryptocurrency wallet to another cryptocurrency wallet. The transferring wallet is a wallet of a customer that is redeeming a predefined amount of cryptocurrency of a given cryptocurrency type to fiat currency by transferring the customer's cryptocurrency to a digital wallet of a gateway service. The gateway service is described in detail below with respect to cloud/server 110 of system 100 and methods 200 and 300.

System 100 includes a cloud 110 or a server 110 (hereinafter referred to as “cloud 110”), one or more FI servers 120, one or more user-operated devices 130, and distributed blockchain (BC) 140. Cloud 110 includes at least one processor 111 and a non-transitory computer-readable storage medium (hereinafter “medium”) 112, which includes executable instructions for a gateway manager 113, a wallet-account manager 114, and Application Programming Interfaces (APIs) 115. The instructions when provided to processor 111 cause processor 111 to perform operations discussed herein and below for 113-115. Cloud 110 processes 113-115 to present at and to provide a gateway service to FIs and customers of the FIs through account service 123 and FI account management app 134 which permits customers to make payment on accounts using cryptocurrency held in their digital wallets while the FIs receive from the gateway service fiat currency as payment from the customers.

Each FI server 120 includes at least one processor 121 and medium 122, which includes executable instructions for an account service 123 and a gateway API 124. The instructions when provided to processor 121 cause processor 121 to perform operations discussed herein and below for 123-124.

Each user-operated device 130 comprises one or more processors 131 and medium 132, which includes executable instructions for a wallet app 133 and a FI account management application (app) 134. When the executable instructions are provided to processor 131, this causes processor 131 to perform operations discussed herein and below 133-134.

Distributed blockchain (BC) devices/servers comprises processors 141 and a non-transitory computer readable storage medium 142 for each BC device/server 140. Medium 140 comprises executable instructions for BC APIs 143. When the executable instructions are provided to corresponding processor 141, this causes processor 141 to perform operations discussed herein and below for BC APIs 143.

An existing FI account management app 134 provided by account service 123 by a FI is enhanced to present within the user interface an option to make a payment on a fiat currency account by a customer using cryptocurrency from a cryptocurrency wallet of the customer. When this novel pay by crypto option is selected by a customer within the user interface, the user interface is redirected to gateway manager 113. Gateway manager 113 receives the fiat currency account identifier for the customer's fiat currency account and a FI identifier associated with the FI server 120. Gateway manager 113 presents a modified user interface to the customer within the FI account management app 134 for the customer to scan a code or a quick response (QR) code that is encoded with a cryptocurrency wallet of the gateway service (cloud 110) using the customer's wallet app 133. The customer opens the wallet app 133 and scans the code, this causes wallet app 133 to request that the customer enter an amount and type of cryptocurrency to transfer from the customer's wallet to the gate service's wallet. Once the amount is entered, the wallet app 133 initiates the transfer of the cryptocurrency from the wallet of the customer to the wallet of the gateway service over distributed BC devices/servers 140 to the blockchain. Wallet-account manager 114 can see the pending blockchain transfer via a blockchain API 115 as a pending cryptocurrency transfer from the customer's wallet to the gateway service's wallet and reports the pending transfer to gateway manager 113.

Gateway manager 113 can maintain a variety of custodial wallets on behalf of FIs within the gateway service wallet and simultaneously maintain at least one financial account with fiat currency. Once the pending transfer of the cryptocurrency from the customer's wallet to the gateway service's wallet is confirmed on the BC by wallet-account manager 114, gateway manager 113 initiates a fiat currency transfer for the converted amount associated with the pending transfer from the fiat currency account of the gateway service to a fiat currency account associated with the FI along with the corresponding fiat currency account identifier of the customer. Account service 123 detects the transfer and the fiat currency account identifier and credits the fiat currency account of the customer with the amount. The user interface of FI account management app 134 is updated to indicate that the customer has been credited the amount.

In an embodiment, the user interface of FI account management app 134 is enhanced to permit a wallet identifier for the customer's crypto wallet to be entered. The wallet identifier is then maintained by account service with account information associated with the customer and/or is maintained by wallet-account manager 114 along with a fiat currency account identifier of the customer with the FI. Thus, the customer may maintain a registered crypto wallet identifier with the customer's fiat currency account information. Gateway manager 113 can monitor the gateway service's wallet on the BC and determine pending transfers originating from the customer's wallet based on the registered customer wallet identifier and when detected, gateway manager 113 can send the fiat currency account identifier along with the converted fiat currency amount from the gateway service's financial account to the financial account of the FI. Account service 123 detects the deposit and uses the customer's fiat currency account identifier to credit the customer's fiat currency account with the corresponding amount. In this embodiment, once a customer has registered their cryptocurrency wallet identifier, the customer can use wallet app 133 outside the context of app 134 to make payments at any time to be applied to their fiat currency account. When the customer does access the user interface of app 134, account service 123 shows the credit payments made by the customer via the customer's wallet app 133.

In an embodiment, the user interface of app 134 is enhanced to directly interact with wallet app 133 using an API. In this embodiment, a user-interface screen for transfer cryptocurrency to the gateway service's wallet is updated to show a balance of the cryptocurrency for each type of cryptocurrency and current conversion rates to the fiat currency. APP 134 may be further updated to identify the current payment needed by the customer on the fiat currency account and show in the user interface the amount of each available type of cryptocurrency needed to make the payment. The amount of each type of cryptocurrency can be changed by the customer and as changes are made the corresponding payment amount to apply is updated. The amount of payment to apply to the fiat currency account can also be updated by the customer within the user interface causing the amount and type of each available cryptocurrency to change accordingly. When the customer selects a payment amount to apply to the fiat currency account within the user interface of all 134, app 134 interacts with wallet app 133 to initiate the transfer of the corresponding cryptocurrency type and amount from the customers wallet to the gateway service's wallet on the BC. Gateway manager 113 can see the pending transfer, the amount, and the customer's wallet identifier on the BC using the gateway service's wallet identifier. Gateway manager 113 transfers the equivalent amount in fiat currency from the gateway service's financial account to the financial account of the FI along with the customer's fiat currency account identifier. Account service 123 sees the fiat currency transfer and updates the fiat currency account of the customer to credit the fiat currency amount, which causes the user interface of app 134 to show the credited amount to the customer.

In an embodiment, wallet-account manager 114 maintains cryptocurrency received through transfers in a stable cryptocurrency coin such as U.S. Dollar Coin (USDC). That is when a transfer completes from a customer wallet to the gateway service's wallet, wallet-account manager 114 uses an exchange to convert the cryptocurrency to the USDC for purposes of minimizing risk to the gateway service.

In an embodiment, wallet-account manager 114 maintains a custodial cryptocurrency wallet on behalf of the FI. In such cases, the wallet-account manager 114 maintains ledger to reflect what is being held in a given FI wallet within the gateway service's wallet. Additionally, in cases where such possession of cryptocurrency wallets by FIs are permitted, gateway manager 113 may send a notice to account service 123 when the transfer from the customer's wallet is initiated on the blockchain to the gateway service's wallet, such that a financial account to financial account transfer between the gateway service and the FI is not needed. In an embodiment of this embodiment, the gateway manager 113 may maintain the cryptocurrency in a stable coin within the custodial wallet of the FI.

In an embodiment, the gateway service may collect a fee for making payments on accounts from the customer, the FI, or both. In an embodiment, gateway service may collect a fee based on an amount of the payment processed. In an embodiment, gateway service may collect a fixed monthly or annual fee from customers, FIs, or both. In an embodiment, gateway service may collect a volume-based fee based on the total number of payments processed in a given time frame on behalf of the customers, the FIs, or both. In an embodiment, gateway service is fee to the FIs as a value added service to the FI.

One now appreciates how system 100 permits an existing account service 123 and FI account management app 134 to be enhanced with a gateway service 113-115, which permits customers of a FI to make payments on accounts utilizing existing cryptocurrency of the customer held in a cryptocurrency wallet of the customer. This integration can occur in band to the user interface of app 133 or out of band to app 133 when the customer has registered their wallet identifier with the gateway service. Out of band means that after wallet registration, the customer can make payments to their fiat currency account outside the context of and without operating app 134. This provides flexibility to the FI and the consumers since many consumers invest in cryptocurrency but have few options to use the cryptocurrency beyond investing and since the FI is often forbidden by regulations from dealing in cryptocurrency. The FI receives timely payments for their accounts, assumes no risk in the cryptocurrency markets, and provides flexible additional payment options to the customers.

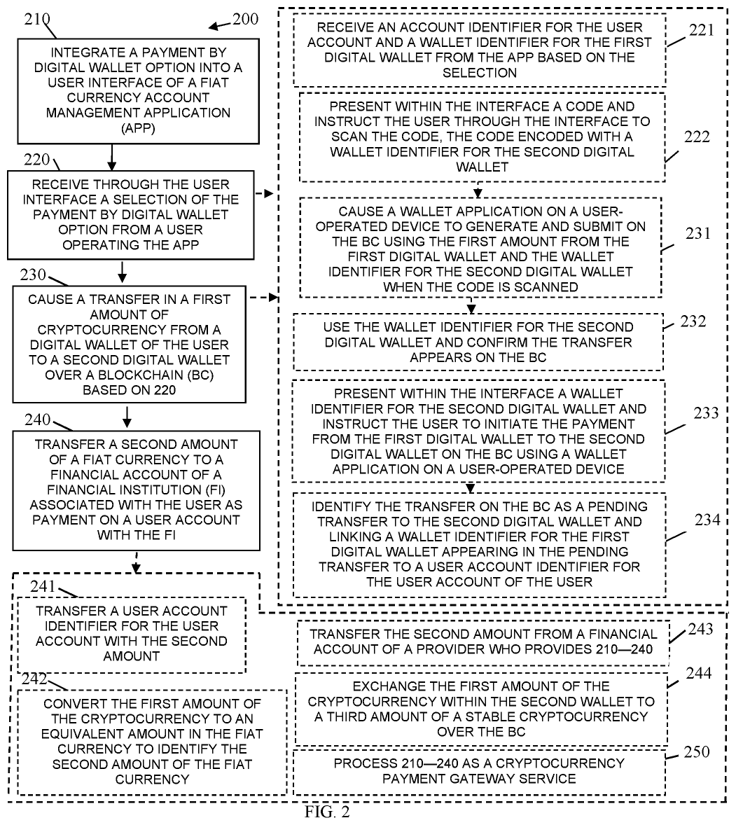

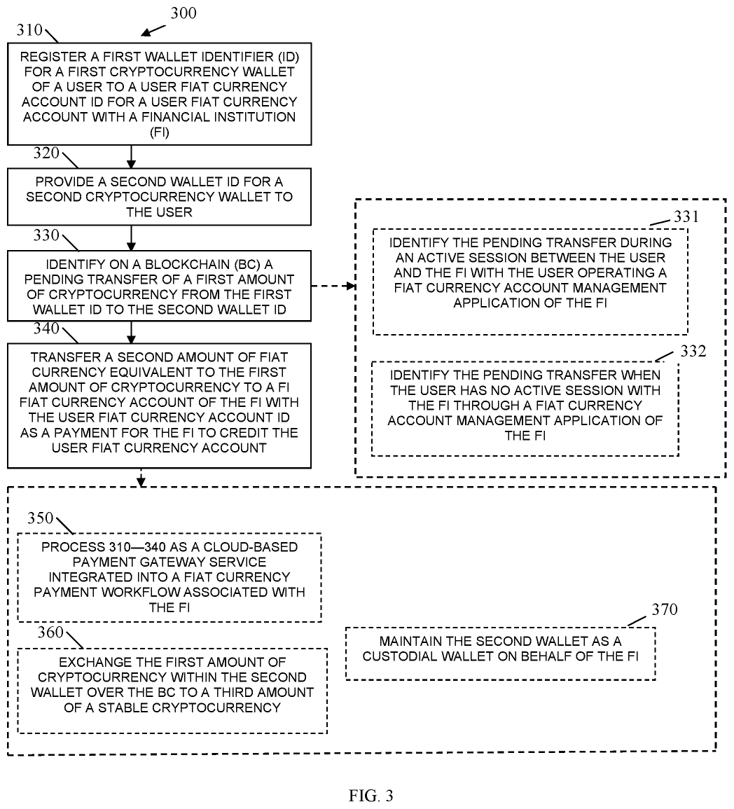

The embodiments of FIG. 1 and other embodiments are now discussed with reference to the FIGS. 2-3. FIG. 2 is a diagram of a method 200 for digital wallet integration with online services, according to an example embodiment. The software module(s) that implements the method 200 is referred to as a “gateway service.” The gateway service is implemented as executable instructions programmed and residing within memory and/or a non-transitory computer-readable (processor-readable) storage medium and executed by a plurality of hardware processors of a plurality of hardware computing devices. The processors of the devices that execute the gateway service are specifically configured and programmed to process the gateway service. The fraud protection manager has access to one or more networks during its processing. The networks can be wired, wireless, or a combination of wired and wireless.

In an embodiment, the devices that execute the gateway service is cloud 110 or server 110. In an embodiment, the gateway service is gateway manager 113, wallet-account manager 114, and/or APIs 115.

At 210, the gateway service integrates a payment by digital wallet option into a user interface of a fiat currency account management app 134. This can be done by redirecting the user during a session with a FI to the gateway service when the user selects the option.

At 220, the gateway service receives through the user interface a selection of the payment by digital wallet option from the user that is operating the app 134 on a user-operated device 130. By selecting the option, the user interface is redirected to the gateway service.

In an embodiment, at 221, the gateway service receives an account identifier for the user account and a wallet identifier for the first digital wallet from app 134 based on the selection. That is, other information associated with the session is provided by the user interface of app 134 to the gateway service, such as the user's account identifier.

In an embodiment, at 222, the gateway service presents within the user interface a code and instructs the user through the user interface to scan a code. The code is encoded with a wallet identifier for a second digital wallet associated with the gateway service on the BC. In an embodiment, the code is a QR code encoded with the second digital wallet identifier for the second digital wallet.

At 230, the gateway service causes a transfer in a first amount of cryptocurrency from a digital wallet of the user to a second digital wallet associated with the gateway service over the BC based on 220. This can be done in a variety of manners.

For example and in an embodiment of 222 and 230, at 231, the gateway service causes a wallet application 133 on a user-operated device 130 to generate and submit the transfer on the BC using the first amount from the first digital wallet and the wallet identifier for the second digital wallet when the code is scanned by the user within the user interface. In an embodiment of 231 and at 232, the gateway service uses the wallet identifier for the second wallet and confirms the transfer is appearing on the BC. That is, the actual transfer takes time to complete depending on the transactions being processed when submitted to the BC, but the gateway service only need confirm that the transfer was initiated and is appearing with the second wallet on the BC.

In an embodiment, at 233, the gateway service presents within the user interface a wallet identifier for the second digital wallet and instructs the user to initiate the payment from the first digital wallet to the second digital wallet on the BC using a wallet application 133 on a user-operated device 130. The actual transfer is initiated from the user's wallet application 133 by the user. In an embodiment of 233 and at 234, the gateway service identifies the transfer on the BC as a pending transfer to the second digital wallet. The gateway service links a wallet identifier registered to the user for the first digital wallet and appearing in the pending transfer to a user account identifier for the user account of the user with the FI.

At 240, the gateway service transfers a second amount of fiat currency to a financial account of a FI associated with the user as a payment on a user account with the FI. That is, while the transfer is pending, the gateway service uses its own maintained financial account to transfer the second amount to the financial account associated with the FI.

In an embodiment, at 241, the gateway service transfers a user account identifier for the user account with the second amount of fiat currency. This permits the FI to properly credit the user account with the payment in the second amount.

In an embodiment, at 242, the gateway service converts the first amount of cryptocurrency to an equivalent amount in the first currency to determine and to identify the second amount of the fiat currency. A cryptocurrency exchange API can be processed to obtain an up-to-date conversion rate between a type of the cryptocurrency and the first amount to the fiat currency of the second amount.

In an embodiment, at 243, the gateway service transfers the second amount from a financial account of a provider who provides the gateway service (210-240). That is, the gateway service has access and account information to a financial account maintained by the provider such that the provider can quickly transfer the second amount to the FI even while the BC transfer remains pending on the BC. An appropriate fiat currency balance is maintained by the provider within the provider's financial account.

In an embodiment, at 244, the gateway service exchanges the first amount of the cryptocurrency within the second wallet to a third amount of a stable cryptocurrency over the BC. In an embodiment, the third amount is equal to the second amount. In an embodiment, the third amount is not equal to the second amount, this can occur when the fiat currency being used by the FI is not the same governmental fiat currency that is associated with the stable cryptocurrency (for example, the fiat currency of the FI is the Euro, and the stable coin is based on the U.S. dollar).

In an embodiment, at 250, the gateway service (210-240) is processed as a cryptocurrency payment gateway service. The gateway service is integrated within a fiat currency payment workflow as option to pay fiat currency to the FI using the user's cryptocurrency held in the first digital wallet of the user.

FIG. 3 is a diagram of another method 300 for digital wallet integration with online services, according to an example embodiment. The software module(s) that implements the method 300 is referred to as a “digital wallet payment integration manager.” The digital wallet payment integration manager is implemented as executable instructions programmed and residing within memory and/or a non-transitory computer-readable (processor-readable) storage medium and executed by one or more hardware processors of one or more hardware devices. The processors of the devices that execute the digital wallet payment integration manager are specifically configured and programmed to process the digital wallet payment integration manager. The digital wallet payment integration manager has access to one or more networks during its processing. The networks can be wired, wireless, or a combination of wired and wireless.

The digital wallet payment integration manager presents another and, in some ways, enhanced processing perspective of that which was described above with system 100 and method 200. In an embodiment, the device that executes the digital wallet payment integration manager is cloud 110 or server 110. In an embodiment, the digital wallet payment integration manager is all or some combination of gateway manager 113, wallet-account manager 114, APIs 115, and/or method 200 of FIG. 2.

At 310, the digital wallet payment integration manager registers a first wallet identifier for a first cryptocurrency wallet of a user to a user fiat currency account identifier for a user fiat currency account with a FI. This can be done through registration or during a payment operation being made by the user to the FI for the user's fiat currency account through app 134 when a cryptocurrency payment option is first being used by the user.

At 320, the digital wallet payment integration manager provides a second wallet identifier for a second cryptocurrency wallet to the user. This can be transparent to the user such as through a QR code scanned by the user or can be explicitly provided to the user through a variety of means.

At 330, the digital wallet payment integration manager identifies on a BC a pending transfer of a first amount of cryptocurrency from the first wallet identifier to the second wallet identifier. The BC permits pending transactions or pending transfers to be viewed via APIs when the second and/or first wallet identifiers are provided through the APIs.

In an embodiment, at 331, the digital wallet payment integration manager identifies the pending transfer during an active session between the user and the FI with the user operating a fiat currency account management app 134 of the FI. That is, the digital wallet payment integration manager confirms the pending transfer in-band with an active session of the user to the FI.

In an embodiment, at 332, the digital wallet payment integration manager identifies the pending transfer when the user has no active session with a fiat currency account management application 134 of the FI. Here, because the first wallet identifier is registered and linked to the user fiat currency account identifier, the digital wallet payment integration manager can identify the pending transfer out-of-band to any session by checking the BC using the second wallet identifier and detecting the transfer associated with the user's first wallet identifier.

At 340, the digital wallet payment integration manager transfers a second amount of fiat currency that is equivalent to the first amount of cryptocurrency to a FI fiat currency account of the FI with the user fiat currency account identifier as a payment. This permits the FI to receive notice of the second amount and of the account identifier linked to the user's fiat currency account so the user account can be properly credited with the second amount.

In an embodiment, at 350, the digital wallet payment integration manager (310-340) processes as a cloud-based payment gateway service that is integrated into a fiat currency payment workflow associated with the FI. The FI's app 134 provides a cryptocurrency payment option that forks or redirects the fiat currency payment workflow to the gateway service in the manners discussed herein and above.

In an embodiment, at 360, the digital wallet payment integration manager exchanges the first amount of cryptocurrency within the second wallet over the BC to a third amount of stable cryptocurrency. The third amount is equal to the second amount when the government backing the fiat currency is a same government associated with the stable cryptocurrency.

In an embodiment, at 370, the digital wallet payment integration manager maintains the second wallet as a custodial wallet on behalf of the FI. In an embodiment, the digital wallet payment integration manager can maintain the custodial wallet for a plurality of other FIs by using ledgers to properly maintain balances for each FI within the single custodial wallet.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
integrating a payment by digital wallet option into a user interface of a fiat currency account management application (app);
receiving through the user interface a selection of the payment by digital wallet option from a user operating the app;
causing a transfer in a first amount from a first digital wallet of the user to a second digital wallet over a blockchain (BC) based on the receiving; and
transferring a second amount of a fiat currency to a financial account of a financial institution (FI) associated with the user as the payment on a user account with the FI.

2. The method of claim 1, wherein receiving further includes receiving an account identifier for the user account and a wallet identifier for the first digital wallet from the app based on the selection.

3. The method of claim 1, wherein receiving further includes presenting within the user interface a code and instructing through the user interface the user to scan the code, wherein the code encoded with a wallet identifier for the second digital wallet.

4. The method of claim 3, wherein causing further includes causing a wallet application on a user-operated device to generate and submit the transfer on the BC using the first amount from the first digital wallet and the wallet identifier for the second digital wallet when the code is scanned.

5. The method of claim 4, wherein causing further includes using the wallet identifier for the second digital wallet and confirming the transfer appears on the BC.

6. The method of claim 1, wherein causing further includes presenting within the user interface a wallet identifier for the second digital wallet and instructing the user to initiate the payment from the first digital wallet to the second digital wallet on the blockchain using a wallet application on a user-operated device.

7. The method of claim 6, wherein presenting further includes identifying the transfer on the BC as a pending transfer to the second digital wallet and linking a wallet identifier for the first digital wallet appearing in the pending transfer to a user account identifier for the user account of the user.

8. The method of claim 1, transferring further includes converting the first amount of the cryptocurrency to an equivalent amount in the fiat currency to identify the second amount of the fiat currency.

9. The method of claim 1, wherein transferring further includes transferring a user account identifier for the user account with the second amount.

10. The method of claim 1, wherein transferring further includes transferring the second amount from a financial account of a provider who provides the method.

11. The method of claim 1, wherein transferring further includes exchanging the first amount of the cryptocurrency within the second wallet to a third amount of a stable cryptocurrency over the BC.

12. The method of claim 1 further comprising, processing the method as a cryptocurrency payment gateway service.

13. A method, comprising:
registering a first wallet identifier for a first cryptocurrency wallet of a user to a user fiat currency account identifier for a user fiat currency account with a financial institution (FI);
providing a second wallet identifier for a second cryptocurrency wallet to the user;
identifying on a blockchain (BC) a pending transfer of a first amount of cryptocurrency from the first wallet identifier of the first cryptocurrency wallet to the second wallet identifier of the second cryptocurrency wallet;
transferring a second amount of fiat currency equivalent to the first amount of cryptocurrency to a FI fiat currency account of the FI with the user fiat currency account identifier for the user fiat currency account as a payment for the FI to credit the user fiat currency account of the user.

14. The method of claim 13 further comprising, processing the method as a cloud-based payment gateway service integrated into a fiat currency payment workflow associated with the FI.

15. The method of claim 13, wherein identifying further includes identifying the pending transfer during an active session between the user and the FI with the user operating a fiat currency account management application of the FI.

16. The method of claim 13, wherein identifying further includes identifying the pending transfer when the user has no active session with the FI through a fiat currency account management application of the FI.

17. The method of claim 13 further comprising, exchanging the first amount of cryptocurrency within the second wallet to a third amount of a stable cryptocurrency.

18. The method of claim 13 further comprising, maintaining the second wallet as a custodial wallet on behalf of the FI.

19. A system comprising:
at least one server that comprises at least one processor;
the at least one processor executes instructions that cause the at least one processor to perform operations, comprising:
linking a cryptocurrency wallet identifier for a cryptocurrency wallet of a user to a user account identifier associated with a user account with a financial institution (FI);
maintaining a second cryptocurrency wallet;
identifying on a blockchain (BC) a payment in a first amount of cryptocurrency being transferred to the second wallet using the cryptocurrency wallet identifier for the cryptocurrency wallet and a second cryptocurrency wallet identifier for the second cryptocurrency wallet;
determining a second amount of fiat currency that is equivalent to the first amount of cryptocurrency;
transferring the user account identifier and the second amount of fiat currency as the payment to a FI account associated with the FI to credit the payment to the user account by the FI in the second amount of fiat currency.

20. The system of claim 19, wherein the operations are integrated into a fiat currency payment workflow of a fiat currency account management application and the operations are activated when the user selects a payment by cryptocurrency option within a user interface of the fiat currency account management application.
